(19) United States
(12) Patent Application Publication
(10) Pub. No.: US 2001/0051900 A1
(43) Pub. Date: Dec. 13, 2001

(54) Interactive display

(76) Inventors: James Robert Fisher, Cronulla NSW (AU); John Igino Kahlbetzer, Vaucluse NSW (AU)

Correspondence Address: CHRISTIE, PARKER & HALE, LLP, 350 WEST COLORADO BOULEVARD, SUITE 500, PASADENA, CA, 91105, US

(21) Appl. No.: 09/765,779

(22) Filed: Jan. 19, 2001

(30) Foreign Application Priority Data
Jan. 19, 2000 (AU) PQ5166

(51) Int. Cl. G06F 17/60

(52) U.S. Cl. 705/26

(57) ABSTRACT

The present invention relates to interactive advertising which permits a vendor to be provided with feedback from interested consumers. A publically accessible data transfer system is also disclosed which permits members of the public equipped with personal digital assistants (PDA) (45) to receive and transmit data via a transponder (9) located on outdoor advertising signs (1) or similar locations. The transponder (9) includes a cache memory (54) and is able to communicate with a server (42) to upload and download data. A system of product data dissemination and a commercial premises data transfer system are also disclosed.

### FIELD OF INVENTION

The present invention relates generally to advertising and the transfer of data utilizing “advertisements” including a transponder.

### BACKGROUND ART

Products, in particular, and to a lesser extent services, are commonly displayed by advertisers who are essentially vendors of the products or services. Typically such advertisements include outdoor advertisements such as posters, billboards, neon lights, etc as well as other forms of advertisements such as appear in print media, etc. Outdoor advertising is normally located in prominent positions in the community such as in airport terminals, at bus shelters, or the sides of road and on buildings. Especially in the case of large display advertisements, the advertiser commonly spends a great deal of money both on producing the advertisement and on renting the advertising space of the display. Despite such large expenditure, the advertiser often has little, if any, feedback as to how many customers like the advertisement, find the product appealing, would like to buy the product etc. except as a result of ad hoc word of mouth communications from customers. Thus, display advertisements have hitherto been a means of present passive media and inviting the customer to remember a brand, phone number or website addess in the hope that the customer will purchase or contact the advertiser of the product or service at a later stage.

The present invention seeks to provide a means by which an interested prospective customer, intending purchaser, etc can contact the advertiser or vendor. From this initial aim, a system for data transfer in a publicly assessable manner has evolved as will be explained hereafter.

### SUMMARY OF THE INVENTION

In accordance with a first aspect of the present invention there is disclosed a publicly accessible data transfer system to permit data from a plurality of sources and destinations to be transferred therebetween, said system comprising:

(i) a plurality of transponders each including a transponder transceiver and a cache memory,

(ii) a server having a memory, communicator means to communicate with said transponders, and means to cycle though each of said transponders in sequence to down load first information from each transponder cache memory to said server memory and up load second information from said server memory to said cache memory, and

(iii) a plurality of portable devices each including a device transceiver able to communicate with said transponder receivers and data generation means to generate device data to be transmitted by said device transceiver,

wherein device data from any predetermined one of said devices can be transmitted via any predetermined one of said transponders to said server, second information from said server can be transmitted via said one transponder to said one device, and device data from said one device can be transmitted via said one transponder to another said device or can be transmitted via said one transponder to said server and via another said transponder to said device.

In accordance with a second aspect of the present invention there is disclosed an interactive advertisement including a transponder having a transponder transceiver and a cache memory, said transponder transceiver being configured to communicate with any one of a plurality of portable device transceivers, and being operatively associated with an icon displayed in said advertisement.

In accordance with a third aspect of the present invention there is disclosed a system of product data dissemination, said system comprising a plurality of advertisements each of which includes a transponder having a cache memory and a transponder transceiver configured to communicate with any one of a plurality of portable device transceivers, said cache memory including stored product data relating to a product displayed by said advertisement, and said stored product data being transmitted from said cache memory via said transponder transceiver to said portable device following receipt of a signal by said transponder transceiver from said portable device transceiver.

In accordance with a fourth aspect of the present invention there is disclosed a commercial premises data transfer system to permit sales data to be transferred, said system comprising:

(i) at least one transponder having a transponder receiver and a cache memory,

(ii) a server having a memory and being connected with said transponder to communicate data in either direction between said server memory and said cache memory, and

(iii) at least one portable device including a device transceiver able to communicate with said transponder receiver and data generation means to generate device data to be transmitted by said device transceiver,

wherein said data transmitted from said device to said server memory comprises sales orders and said data transmitted from said server memory to said device comprises product availability data.

### BRIEF DESCRIPTION OF THE DRAWINGS

FIG. 1 is a schematic perspective view of a first embodiment of the present invention showing an interactive display and two forms of message transmitter,

FIG. 2 is a block diagram of a display system incorporating a multiplicity of the interactive displays of FIG. 1,

FIG. 3 is a block diagram of a second embodiment of a display system incorporating a multiplicity of the interactive displays of FIG. 1,

FIG. 4 is a schematic perspective view of a vendor's premises incorporating a single interactive display,

FIG. 5 is a schematic block diagram of the circuit components incorporated in the server and interactive displays of FIG. 4,

FIG. 6 is a schematic perspective view of a location having a number of interactive displays and a number of customers, and

FIG. 7 is a schematic block diagram similar to FIG. 5 but for the arrangement of FIG. 6.

### DETAILED DESCRIPTION OF PREFERRED EMBODIMENTS

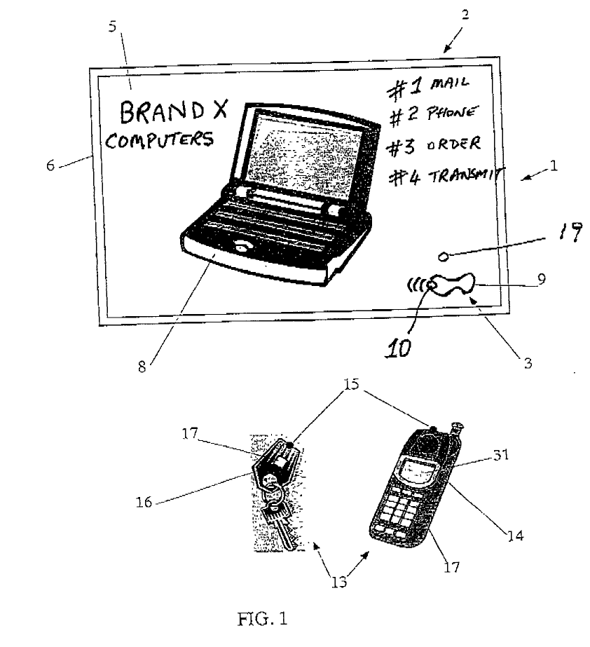

According to a first embodiment of the present invention there is disclosed, as shown in FIG. 1, an interactive display 1 including a billboard 2 and message transceiver 3. The billboard 2 has a peripheral frame 6 and carries an advertisement 5 which in this case is for a laptop computer 8.

As seen in FIG. 1, the message transceiver 3 includes a transponder logo 9 in the form of a BLUEFISH (trade mark) the eye of the fish logo 9 being an infra-red receiver and transmitter 10.

In accordance with this embodiment, a customer having a portable transmitter 13 sends a message to the transceiver 3. Although the portable transmitter 13 is able to take on a variety of forms, two preferred embodiments are shown in FIG. 1. The first preferred embodiment of the transmitter 13 is a mobile phone 14 which includes an infra-red transceiver 15. Such mobile phones are commonly known, include buttons 17 and are therefore able to be readily adapted to be used with the interactive display 1.

The second preferred embodiment of the transmitter 13 also shown in FIG. 1, is a single purpose held-held unit, such as a key ring 16 which includes an infra-red transceiver 15 (or just a transmitter) and one or more buttons 17.

In use, a customer reads the advertisement 5 on the billboard 2 and, if the customer is interested in the product, the customer points the infra-red transceiver 15 of their transmitter 13 towards the transceiver 3 on the interactive display 1 and presses one or more buttons 17. In the preferred embodiment the display information includes an indication of the buttons 17 which the customer should press, depending upon the type of message they want send. For example, if the customer wants the advertiser to send them by mail or e-mail a brochure, order form etc. about the product or service advertised, they should press “#1”. If the customer wants the advertiser to contact the customer by telephone, the customer should press “#2”. If the customer wants to purchase the product or service from the advertiser, the customer should press “#3”. If the customer wanted information transmitted back to their transmitter 13, the customer should press “#4”. Numerous other combinations of buttons and/or messages are also envisaged.

In this way, a previously passive media of an advertisement on a billboard, or an equivalent display is able to become an interactive display, not only allowing a customer to order products, or gain further information, but also providing the advertiser or information provider with feedback as to how successful the advertisement was.

In an advanced embodiment of the present invention, the display 1 is an LCD, television or plasma screen which responds to the first message sent by the transmitters 13, thereby enabling a customer to then select an option from an hierarchical menu of choices. For example, where the advertiser has a number of models of lap-tops for sale in response to the customer's first message, the advertisements changes to the menu of choices. The customer then sends a second message to select a particular model by pressing an appropriate button 17 (or combination of buttons). The advertisement 5 therefore responds to, and interacts with the customer. Additional options are possible by means of detailed instructions printed on the advertisement 5. The LCD, LED or plasma versions permit much more complicated levels of menus and options thereby decreasing the number of buttons 17 in a sequence which the customer is required to press.

The message sent by the customer to the transceiver 3 preferably includes a variety of information, including (but not limited to) the customer's name, address, phone number, email address, age, identification number, (e.g. social security number), credit card information etc. Such information can be pre-stored within the mobile phone 14, for example.

Once the interactive display 1 has received a message from the customer, a message confirmation device, such as a light 19, is preferably activated, so that the customer knows that the message has been received. Alternatively, the message confirmation can be achieved by sending a confirmation message to the mobile phone 14 which the customer reads on the screen 31 of the mobile phone 14. In alternative embodiments, the confirmation message includes additional product information, such as product prices, lead times, etc.

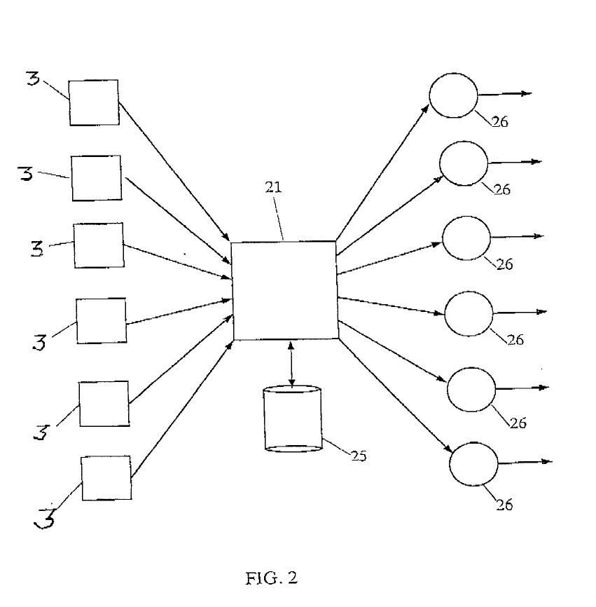

Once the initial message has been received by the transceiver 10, it is able to be dealt with by the transceiver 10 in a variety of ways. One preferred embodiment is illustrated in FIG. 2. In this preferred embodiment, a multiciplicity of interactive displays, which each include a message transceiver 3, all transmit customer requests to a base station 21. Each customer request transmitted preferably includes at least customer information, customer request information and display identification information. When the base station 21 receives a customer request, it interacts with a database 25 in order to associate one of a number of advertisers or information providers 26 with each particular interactive display 1. The base station 21 then on-sends the customer request to the particular information provider 26. The request on-sent preferably includes at least- customer information. The customer provider 26 then responds to the customer request in an appropriate way, such as by sending the customer brochures, contacting the customer by telephone or e-mail, or processing the customer's purchase request, and delivering the product-service to the customer.

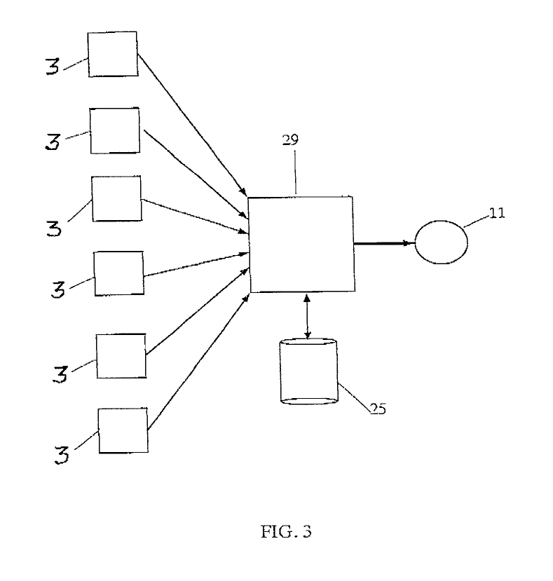

The embodiment illustrated in FIG. 2 is designed especially for. use with billboards 2 which are situated in public areas, such as displays in airports, bus shelters, on the sides of buildings etc. An alternative embodiment, illustrated in FIG. 3 is appropriate for use in a single vendor situation such as a supermarket or department store. In such an embodiment, the customer views the advertisement(s) 5 on a multiplicity of interactive displays and, if the customer would like to purchase any particular product, the customer uses the transmitter 13 to send a message to the transceiver 10 on the display 1 (see FIG. 1). Each of the multiplicity of transceivers 3, once they receive a message from a customer sends the customer request to a vendor 29. The vendor 29 then processes the customer order in a variety of ways. In one embodiment, the vendor produces a list of products ordered by a customer and has the products packaged together and delivered to the customer. Alternatively, the products could be packaged and held for the customer to pick up either as they are leaving the store, or shortly thereafter. In one preferred embodiment, the customer's order is processed each time they send a message, and the total charged to an appropriate payment means, such as a credit card, so that the customer need only sign off on the purchase(s) as they leave the department store or supermarket. In a further embodiment, the customer's credit card information is securely stored in the database 25 in an appropriate manner. In an alternative embodiment, for example in a women's fashion store, the customer request is simply used to add the customer's details to the catalogue mailing list.

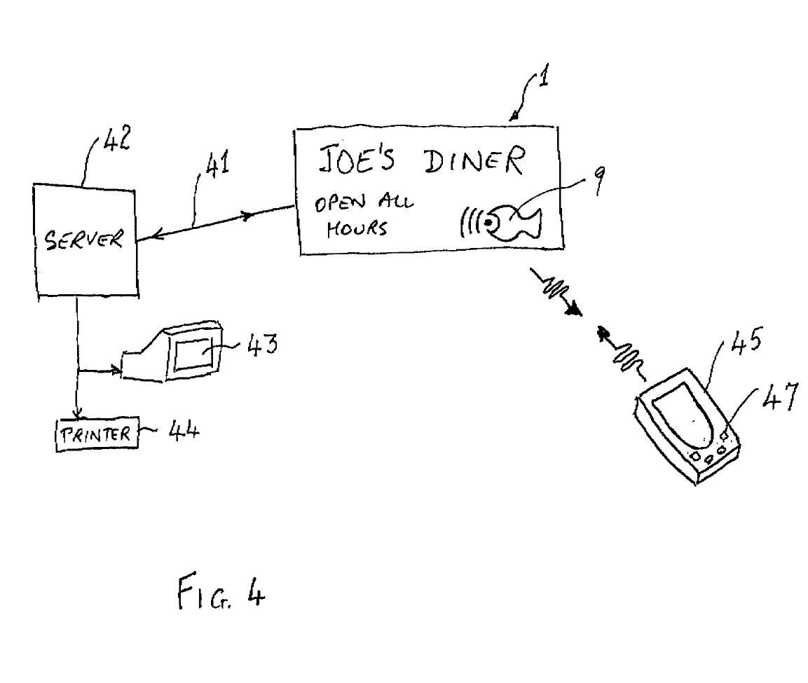

Turning now to FIG. 4, schematically illustrated wherein is the premises of “JOE'S DINER” where an interactive display 1 is positioned at a prominent location within the premises. The display 1 is connected by wiring 41 to a server 42 which is in turn connected to a visual display unit (VDU) 43 and a printer 44.

A waitress whose job it is to take orders within the premises is provided with a Personal Digital Assistant (PDA) 45 such as that sold under the Registered Trade Mark PALM PILOT and preferable the AVANTGO model thereof. The waitress can take an order from a customer, enter the order into the PDA 45 and then point the infra red communication port (not illustrated) of the PDA at the BLUEFISH logo 9. Pressing one of the buttons 47 on the PDA45 up-loads the data entered into the PDA 45 to the transceiver 3 of the interactive display 10.

The transceiver 3 then transmits the order to the server 42 which in turn causes the order to be displayed on the VDU 43 located in the kitchen. In this way the customer's order is transferred to the kitchen without the waitress having to walk to the kitchen or call out to the kitchen.

Further, information can be transmitted in the reverse direction as illustrated in FIG. 4. Thus, if a menu item is exhausted, a signal can be sent from the server 42 via the transceiver 10 to the PDA 45. Thus the waitress can advise the next customer who proposes to order that menu item that it is unavailable.

When a customer requests the invoice at the conclusion of the meal, the waitress inputs the request into the PDA 45 and again points the PDA 45 at the BLUEFISH logo 9 and presses button 47 on the PDA 45. This results in a print request being sent from the PDA 45 via the transceiver 3 to the server 42 which, in turn, instructs the printer 44 to print the invoice. Thus the printed invoice is immediately ready for the customer at the printer which is preferably located adjacent the exit and cash register.

Alternatively, the waitress can input the customer's credit card details into the PDA 45. This then enables a credit card chit to be printed by the printer 44 or an electronic funds transfer at point of sale (EFTPOS) transaction to be conducted via the server 42.

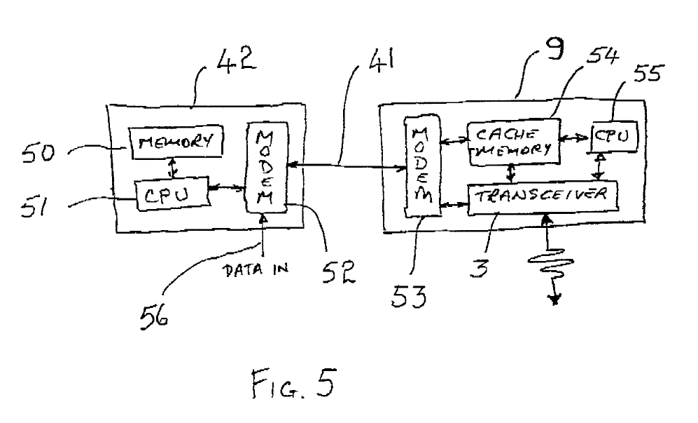

FIG. 5 shows in block diagram form the contents of the display 1 and server 42. The server 42 has memory 50 which is connected with a central processor unit (CPU) 51. The CPU is also connected with a modem 52 which communicates with the display 1 via wiring 41.

In the display 1 is located an equivalent modem 53 which is connected to both a cache memory 54 and the transceiver 3 (which are also inter-connected). A display CPU 55 is also connected to both the cache memory 54 and transceiver 3.

The memory 50 is able to be loaded with data such as the available menu items and their code numbers via a DATA IN line 56 which connects the modem 52 to a keyboard (not illustrated), for example. This data can then be conveyed to the cache memory 54 and transmitted to the PDA 45 via the transceiver 3.

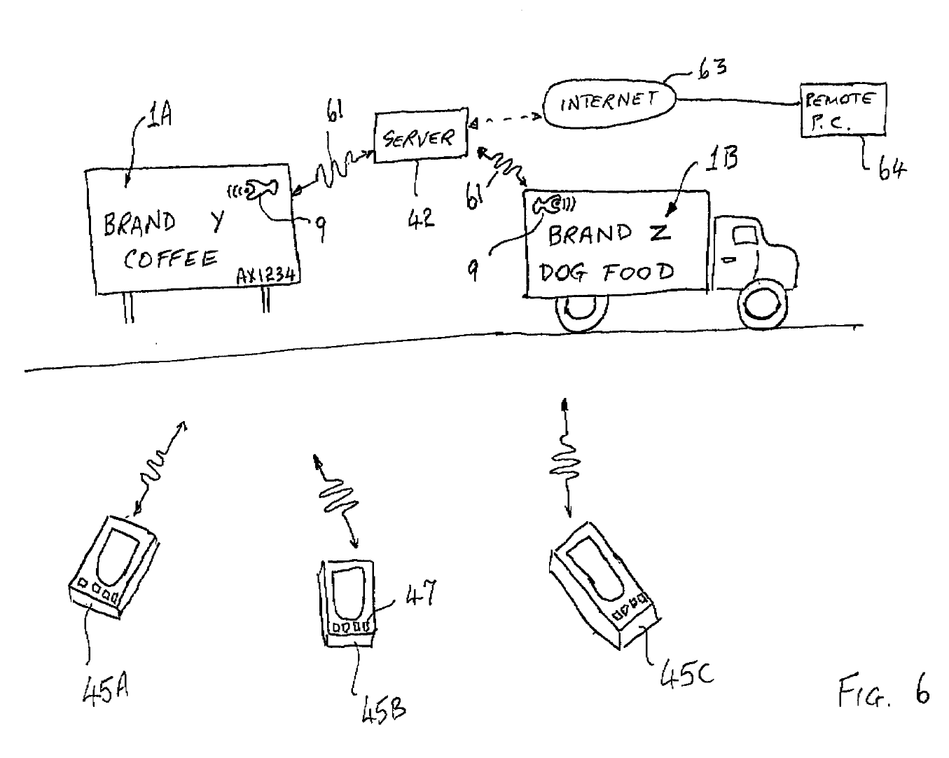

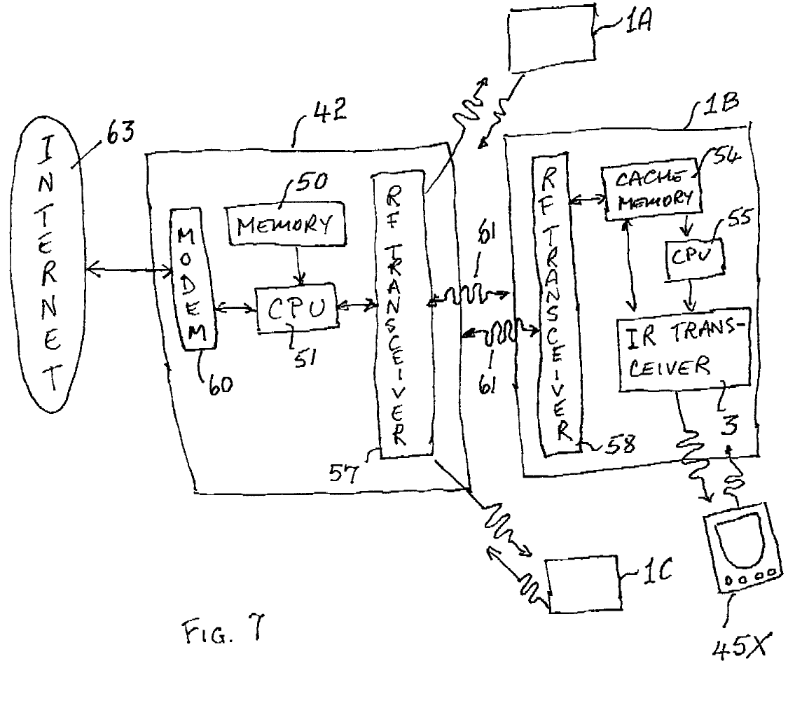

The same basic form of server 42 and interactive display 1 is also able to be used in the situation illustrated in FIGS. 6 and 7. Here there are a number of interactive displays illustrated in the form of a billboard interactive display 1A which is stationary, and vehicle side interactive display 1B which is mobile. Other forms of display include a shop window display, a kiosk display, etc which are not illustrated. The billboard displays are connected to the server 42 as before but via a spread spectrum radio frequency communications link 61. Other forms of communication include but are not limited to infra-red, microwave, ultrasonic, RF, sonar or laser signals. One or more remote personal computers (PC) 64 can be connected via the internet 63 to the server 42 in known fashion.

Preferably the RF communication 61 between the server 42 and any transponders 9 with which it so cornmunicates, takes place in the unlicensed 900 MHz band and at a speed of 19.6 Kb/s. A typical range is approximately 1 mile and line of sight communication. Each server 4 is able to service 200-500 of the transponders 9 and sequentially polls same in order to provide transmission management. The link between each transponder 9 and the PDA's 45 is preferably by means of infra-red (IR) transmission at a rate of from 115 Kb/s up to 4 Mb/s. As the cache memory is preferably 8 MB, the exchange of data between PDA 45 and transponder 9, typically takes less than 5 seconds. The range of communication between the transponder 9 and PDA 45 is typically 1 meter (3 feet).

The arrangement illustrated in FIG. 6 constitutes a self contained communications system which is analogous to, but different from, known mobile phone systems.

As schematically indicated in FIG. 6, any of a number of PDA's 45A, 45B, 45C etc. can communicate with any of the interactive displays 1A, 1B etc. Preferably eight channels are available for communications between the PDA's 45 (which can, for example, be BLUEFISH enabled) and the displays 1 and each cache memory 54 of each display holds 8 Mbits. Further, each 10 minutes or so the server 42 cycles amongst the displays to either up load or down load information to or from the cache memories 54 as required.

Thus the organisation providing the network capability and server 42 can offer channels of data to subscribers. Thus a subscriber with a PDA45A, for example, can download for display on the screen of the PDA45A data such as news summaries, stock exchange prices, weather forecasts, sports results, etc. Alternatively, and/or additionally a traveling salesman having a PDA45C, for example and waiting for a bus whilst sitting in a kiosk having display 1 can download from his PDA45C sales orders received previously and entered into the PDA by the salesman. Such sales orders can be transmitted to the display 1 together with the universal resource location (URL) of the remote PC64 which collects such orders and sends the goods for despatch.

Similarly, such a traveling salesman is able to have transferred to him messages such as emails sent by third parties via the intemet to his remote PC64. Also two individuals having PDA's 45A and 45B, for example, are able to communicate with each other via the BLUEFISH logo 9 of display 1A, for example and exchange diary information with a view to ensuring that appointment clashes are avoided.

As indicated in FIG. 6, BRAND Y coffee can include in its advertising a particular alphanumeric code, in the example of FIG. 6 the code is AX1234. This code can be used in radio, TV and print advertising in addition to the advertisement 5. The interested customer is then able to enter the code AX1234 into his PDA 45. Then either at the same time, or at a later date, the PDA 45 is used to send the code to any BLUEFISH logo 9 and its associated transceiver. This results in sales data pertaining to the advertisement or product displayed on the display 1A being down loaded to the PDA 45A. This data is then able to be read either immediately or at a later time by the interested customer and can be regularly updated by the advertiser.

Standard PDA's come equipped with a “business card” function in the form of a button, which when pushed transmits a set of identifying data including the name, address, contact details, etc of the PDA user to other PDA users. A BLUEFISH enabled user has a slight modification to their “business card” function. Preferably this data is transferred as conventional ASCII characters and the modification is that the last two characters transferred are two carriage return characters. These two carriage returns enable the transponder 9 to recognise if the user is already a customer of the BLUEFISH data transfer system.

If the two carriage returns are present, their presence is effectively ignored by the cache memory 54. However, if the two carriage returns are not present, then transponder 9 is triggered into sending BLUEFISH enabling software to the PDA 45 at an initial transmission between the transponder 9 and the PDA 45.

The traditional way for such software to be loaded into a PDA is for the user to contact www.bluefishwirewless.com via a PC. enroll and then download the enabling software. At the same time personal credit card information can also be registered. If then the PDA and PC of the user are inter connected, the enabling software can be transferred from the PC to the PDA which is then ready for use.

In the above described data transfer via transponder 9, the PDA is preferably a PALMPILOT with AVANTGO software loaded therein and the business card “beaming” function thereof is modified by the enabling software to generate the above described dual carriage return. This then ensures that irrespective of how the user “enrolled”, once enrolled the transponder 9 will recognise the user.

The preferred form of personal digital assistant (PDA) 45 includes a IR transceiver and one of its four buttons 47 is for “beaming” or operating the built-in transceiver. The user of such a PDA device only has to hold down button 47 to receive information. The information received can be any information or transaction based content which the advertiser wishes to transmit from the display 1. Customised BLUEFISH information channels are also preferably updated during such transmissions.

During such transmissions the user of the PDA 45 is also sending information as well as receiving information. The new information will include transactions recently performed, the PDA user's email outbox, and a user identification code, with, which ultimately received by the server 42 will be matched with the user information stored in memory 50 at the time the user was enrolled.

As seen in FIG. 7 the server 42 of FIG. 6 is modified relative to the server 42 of FIG. 5 by the inclusion of a modem 60 to permit communication via the internet 63. In addition, the server 42 includes a RF transceiver 57 to enable radio communication with a similar RF transceiver 58 in the display (1B in FIG. 7). Thus the display 1B of FIG. 7 is also modified relative to the display 1 of FIG. 5 in that the RF transceiver 58 replaces the modem 53 of FIG. 5. Although the transceiver 3 of FIG. 7 is indicated as an IR transceiver (to distinguish it from the RF transceiver 58), it will be appreciated by those skilled in the art that the transceiver 3 can use other modes of transmission (such as RF) instead of infra-red. However, the IR transmission is presently the most convenient.

The above described arrangements are also able to be used with Wireless Application Protocol (WAP) enabled mobile phones. Such phones do not have any built in intelligence (unlike a PDA) but do have an IR communications port. Since WAP enabled communication charges are presently very expensive, the above described arrangement enables the use of WAP to be avoided.

In a first embodiment, the WAP enabled mobile phone is used to transmit via the BLUEFISH logo 9 and its associated transceiver 3 the identity number of the mobile phone, plus the advertisement specific code AX1234, for example. This information is then transmitted by any route to the telephone company together with the requested product data. Since the telephone company knows both the telephone number and the billing name and address of the mobile phone subscriber, the requested information can be sent by mail to the phone subscriber or can be sent by voice mail or text message to the mobile telephone itself.

The telephone company is able to charge for this activity and include the charge in the next invoice sent to the subscriber.

In an alternative arrangement, the mobile phone user can “beam” his phone onto the display 1B of FIG. 6 for example and request the product identification code (which is not displayed on the dog food advertisement). This code, say BZ4321, is then transmitted by the display 1B to the mobile phone. The code BZ4321 can then be sent via the mobile phone network to the telephone company which then ascertains the data and sends it to the mobile phone subscriber as before.

### Industrial Application

The cost of the apparatus described herein is substantially less than known apparatus of equivalent, or near-equivalent functionality. For example, the transponder 9 and server 42 plus PDA 45 of FIG. 4 costs in the vicinity of US$1,000. To this needs to be added software in the vicinity of approximately US$1,000. Thus, for an outlay of the order of US$2,000 the vendor is able to create a meal ordering system for which an equivalent purpose built system sold by NCR Inc. and enlisting a transponder without cache memory 54, for example, sells for approximately US$56,000.

Further, whilst in a conventional mobile phone system the telephone company must pay for the cost of all transmitters and repeaters in the system and hope to recoup this cost through subscriber access, subscriptions and usage charges, in the above described arrangements an advertiser pays subscriptions at a premium rate in order to advertise its products or services and is prepared to pay that premium rate because it receives feedback about the number of “hits” its advertisements receive and receives the added functionality of generating direct sales from their advertisement. It also obtains marketing data about the profiles of customers and prospective customers—something that a passive billboard is quite unable to provide, even if a particular new advertisement is deemed to be a success. As a consequence of this advertising revenue, a publicly available network is built at the client's expense rather than at the owner's expense. This represents a significant saving relative to a mobile telephone network, for example.

In a still further embodiment, once the mobile phone user is aware of the code BZ4321, the mobile phone user can use the WAP internet facility to request the described information directly from the advertiser or information provider.

The foregoing describes only some embodiments of the present invention and modifications, obvious to those skilled in the art, can be made thereto without departing from the present invention.

The term “comprising” as used herein is used in the inclusive sense of “having” or “including” and not in the exclusive sense of “consisting only of”.

1. A publically accessible data transfer system to permit data from a plurality of sources and destinations to be transferred therebetween, said system comprising:
(i) a plurality of transponders each including a transponder transceiver and a cache memory,
(ii) a server having a memory, communicator means to communicate with said transponders, and means to cycle though each of said transponders in sequence to down load first information from each transponder cache memory to said server memory and up load second information from said server memory to said cache memory, and
(iii) a plurality of portable devices each including a device transceiver able to communicate with said transponder receivers and data generation means to generate device data to be transmitted by said device transceiver,
wherein device data from any predetermined one of said devices can be transmitted via any predetermined one of said transponders to said server, second information from said server can be transmitted via said one transponder to said one device, and device data from said one device can be transmitted via said one transponder to another said device or can be transmitted via said one transponder to said server and via another said transponder to said device.

2. The data transfer system as claimed in claim 1 wherein said transponder transceivers and said device transponders communicate via line of sight transmission.

3. The data transfer system as claimed in claim 2 wherein said transponders utilize infra-red transmissions.

4. The data transfer system as claimed in claim 1 wherein said communicator means is selected from the group consisting of hard wired connection, radio frequency communication, telephone communications and intemet communications.

5. The data transfer system as claimed in claim 1 wherein at least some of said transponders are mobile.

6. The data transfer system as claimed in claim 1 wherein said transponder is located on a displayed advertisement and said second information relates to a product displayed by said advertisement.

7. The data transfer system as claimed in claim 6 wherein said first information relates to sales orders for said displayed product.

8. The data transfer system as claimed in claim 1 wherein said first information comprises or includes data identifying the user of one of said portable devices, said first information being transmitted from said one portable device to the transponder cache memory where said first information is stored.

9. The system as claimed in claim 8 wherein said identification data includes a plurality of adjacent carriage return signals.

10. The system as claimed in claim 9 wherein said cache memory includes portable device enabling software and receipt of said plurality of adjacent carriage return signals triggers said transponder to transmit said software to said portable device.

11. An interactive advertisement including a transponder having a transponder transceiver and a cache memory, said transponder transceiver being configured to communicate with any one of a plurality of portable device transceivers, and being operatively associated with an icon displayed in said advertisement.

12. An advertisement as claimed in claim 11 wherein said transponder transceiver operates by line of sight communication and said icon constitutes a target at which said device transceivers are aimed.

13. An advertisement as claimed in claim 12 wherein said icon comprises a fish device.

14. A system of product data dissemination, said system comprising a plurality of advertisements each of which includes a transponder having a cache memory and a transponder transceiver configured to communicate with any one of a plurality of portable device transceivers, said cache memory including stored product data relating to a product displayed by said advertisement, and said stored product data being transmitted from said cache memory via said transponder transceiver to said portable device following receipt of a signal by said transponder transceiver from said portable device transceiver.

15. A system as claimed in claim 14 wherein said advertisement displays at least one alphanumerical data set and said cache memory stores a different product data set corresponding to each said alphanumerical data set, and wherein following receipt of said signal from said device transceiver by said transponder receiver which comprises or includes the alphanumerical data set, or one of said alphanumerical data sets, the transponder transceiver transmits the corresponding product data set.

16. The system as claimed in claim 14 wherein following receipt of said stored product data, said portable device transmits to said transponder identification data identifying the user of said portable device.

17. The system as claimed in claim 16 wherein said identification data is conveyed to the vendor of said displayed product.

18. The system as claimed in claim 16 wherein said identification data includes a plurality of adjacent carriage return signals.

19. The system as claimed in claim 18 wherein said cache memory includes portable device enabling software and receipt of said plurality of adjacent carriage return signals triggers said transponder to transmit said software to said portable device.

20. The system as claimed in claim 14 wherein said portable device transceiver is a mobile phone having push buttons to accomplish dialing and said signal received by said transponder transceiver is generated by operation of one or some of said push buttons.

21. The system as claimed in claim 14 wherein said portable device transceiver comprises the transceiver of a personal digital assistant.

22. A commercial premises data transfer system to permit sales data to be transferred, said system comprising:
(iii) at least one transponder having a transponder receiver and a cache memory,
(iv) a server having a memory and being connected with said transponder to communicate data in either direction between said server memory and said cache memory, and
(iii) at least one portable device including a device transceiver able to communicate with said transponder receiver and data generation means to generate device data to be transmitted by said device transceiver,
wherein said data transmitted from said device to said server memory comprises sales orders and said data transmitted from said server memory to said device comprises product availability data.

23. The system as claimed in claim 22 wherein said portable device comprises a personal digital assistant.

24. The system as claimed in claim 23 wherein said personal digital assistance communicates with said transponder via infra-red transmissions.
